(19) United States
(12) Patent Application Publication
(10) Pub. No.: US 2026/0358830 A1
(43) Pub. Date: Nov. 12, 2026

(54) VEHICLE COMBINATION AND METHOD FOR A SECURE ACTIVATION OF A LEADER-FOLLOWER MODE

(71) Applicant: AGCO International GmbH, Neuhausen Am Rheinfall (CH)

(72) Inventors: Pitt OPPERMANN, Marktoberdorf (DE); Klaus-Jürgen SATZGER, Marktoberdorf (DE); Christian Roberto KELBER, Marktoberdorf (DE); Christian JENTH, Marktoberdorf (DE)

(21) Appl. No.: 19/474,489

(22) PCT Filed: Mar. 8, 2024
(86) PCT No.: PCT/IB2024/052253

§ 371 Date: Oct. 10, 2025

(30) Foreign Application Priority Data
Apr. 12, 2023 (GB) 2305364.8

(51) Int. Cl. G05D 1/69; A01B 69/04; G05D 105/15; G05D 107/20

(52) U.S. Cl. CPC G05D 1/69; A01B 69/008; G05D 2105/15; G05D 2107/21

(57) ABSTRACT

A vehicle combination (1) includes a first vehicle (2) with a first control unit (12) and a second vehicle (4) with a second control unit (24). The first control unit (12) is configured to operate the first vehicle (2) in a leader mode. The second control unit (24) is configured to operate the second vehicle (4) in a follower mode, to receive a signal to activate the leader-follower mode and to enable automated driving of the second vehicle (4) in the follower mode when the signal to activate the leader-follower mode has been received. A related method is also disclosed.

### FIELD

The present disclosure relates generally to a vehicle combination and a method for a secure activation of a leader-follower mode. When the leader-follower mode is activated, a follower vehicle of the vehicle combination is configured to automatically follow a leader vehicle of the vehicle combination.

### BACKGROUND

WO 99/18482, entitled “A vehicle combination”, published on Apr. 15, 1999, discloses a vehicle combination configured to be operated in a leader-follower mode. A master vehicle of the vehicle combination comprises a control system for controlling a satellite vehicle of the vehicle combination so that the master vehicle is operated in a leader mode and the satellite vehicle is operated in a follower mode. The satellite vehicle may be unmanned. Since the satellite vehicle is automatically following the master vehicle, e. g. along a path parallel to a path of the master vehicle, an operator of the master vehicle can double his working capacity.

EP 1 064 182 B1 discloses an electronic braking system for a vehicle. A brake actuator generates a brake force in accordance with electronic signals corresponding to a operator's demand. A mechanical latch is configured to mechanically hold the brake in an applied condition irrespective of whether the brake force generated by the brake actuator is reduced after the mechanical latch has been engaged. Thus, a driving away of the vehicle can be electronically disabled.

International application PCT/IB2022/060583, entitled “Vehicle being operable in an autonomous driving mode and activation device for activating the autonomous driving mode”, filed on Nov. 3, 2022, which is hereby incorporated by reference in its entirety, discloses a vehicle being operable in an autonomous driving mode comprising a parking brake. The parking brake can be applied by pulling a brake lever mechanism. The autonomous driving mode can be activated by an activation device when the brake lever is applied. The activation device may be a button and may be integrated in the brake lever mechanism.

### BRIEF SUMMARY

A leader-follower mode enables an unmanned follower vehicle of a vehicle combination to follow automatically an operator controlled leader vehicle of the vehicle combination. Since operation of an unmanned vehicle may involve a higher risk of accidents or injuries it is an objective to ensure a secure activation of the leader-follower mode for risk reducing.

According to an aspect of the invention there is provided a vehicle combination for a secure activation of a leader-follower mode comprising a first vehicle with a first control unit and a second vehicle with a second control unit. The first control unit is configured to operate the first vehicle in a leader mode. The second control unit is configured to operate the second vehicle in a follower mode, to receive a signal to activate the leader-follower mode and to enable automated driving of the second vehicle in the follower mode when the signal to activate the leader-follower mode has been received.

The first and second vehicle may be of any type as for example the type of an agricultural vehicle such as a tractor, a self-propelled windrower, a self-propelled sprayer or a harvester. The first and second vehicles may be of the same or different type. The first vehicle may be a manned vehicle controlled by an operator. The second vehicle may be an unmanned vehicle controlled automatically. When the first vehicle is operated in the leader mode and the second vehicle is operated in the follower mode, the second vehicle will automatically follow the first vehicle. For example, the second vehicle may automatically drive behind the first vehicle and/or along a path being parallel to a path of the first vehicle and process a field operation in an agricultural field. The field operations of the first and second vehicle may be different when both vehicles drive behind each other or may be the same when both vehicles drive on parallel paths. The second vehicle may mimic any operation of the first vehicle when the second vehicle follows the first vehicle. For example, the second vehicle may mimic a turn around of the first vehicle in the agricultural field or the control of an implement controlled by the first vehicle. The first and the second vehicle may comprise each a communication device connected with their corresponding control units to exchange data or signals. Thus, the first vehicle may send control signals to the second vehicle for mimicking the operation of the first vehicle and/or any implements controlled by the first vehicle.

The activation of the follower mode of the second vehicle can be actively controlled to prevent an unintentional automatic operation of the second vehicle. Before activation of the follower mode of the second vehicle, the operator may check whether the second vehicle is ready for use in follower mode and/or whether the vicinity of the second vehicle is free of any (living) obstacles. Thus, the risk of accidents or injuries caused by the second vehicle can be reduced. So, automated driving of the second vehicle in the follower mode may be prevented if the second control unit of the second vehicle has not received the signal to activate the leader-follower mode and may be enabled after the signal to activate the leader-follower mode has been activated.

The second control unit may be configured to disable an activation of the leader-follower mode unless the second control unit has received a confirmation of a request for activation of the leader-follower mode.

The second control unit may send a request for activation of the leader-follower mode to be confirmed before activation of the leader-follower mode. The second control unit may ignore any signal to activate the leader-follower mode sent to the second vehicle as long as the second control unit has not received the confirmation of the request for activation of the leader-follower mode. Thus, the leader-follower mode may not be activated unintentionally for the second vehicle.

The second control unit may be configured to enable a request for activation of the leader-follower mode if at least one precondition may be fulfilled.

I. e., requesting the activation of the leader-follower mode may depend on the fulfillment of the at least one precondition. Thus, activation of the leader-follower mode may not be requested unintentionally or if the second vehicle is not ready to be used in the follower mode.

The at least one precondition may comprise the precondition of an established communication connection between the first vehicle and the second vehicle, the precondition of an activated sensor for environmental perception of the second vehicle, the precondition of an activated geofence for the second vehicle, the precondition of an operable automated service brake of the second vehicle, and/or the precondition of an operable automated steering of the second vehicle.

Requesting the activation of the leader-follower mode may be prevented if a safe operation of the second vehicle can not be considered. The fulfillment of at least one of the preconditions may improve a safe operation of the second vehicle. For example, an established communication connection between the first vehicle and the second vehicle may provide sending control signals to the second vehicle for a safe vehicle control. The control signals may stop any operation the second vehicle in case of a malfunction.

The activation of a sensor for environmental perception of the second vehicle may provide surveilling the vicinity of the second vehicle and checking in respect of any potential collision with an object being close to the second vehicle.

The activation of a geofence of the second vehicle may prevent the second vehicle to cross unintentionally the geofence and to drive automatically beyond the geofence. The second vehicle may automatically be stopped if the second vehicle approaches the geofence too close. Thus, automated driving of the second vehicle may be restricted to a geographical region being explicitly released for automated driving.

The second control unit may execute a self-check of the service brake of the second vehicle to check the automated operability of the service brake. The self-check may fail if the service brake can not be applied automatically or if a brake signal sent to the second vehicle does not apply the service brake of the second vehicle.

The second control unit may execute a self-check of the steering of the second vehicle to check the automated operability of the steering. The self-check may fail if the steering can not be controlled automatically or if a steering signal sent to the second vehicle does not control the steering of the second vehicle accordingly.

The second control unit may be configured to determine the geofence based on a position signal of the second vehicle.

The second vehicle may comprise a GNSS receiver for receiving a position signal from a global navigation satellite system (GNSS) such as GPS for determining its vehicle position. Based on the positional information of the second vehicle, the second control unit may determine whether the second vehicle is located in a geographical region covered by a geofence. If so, the second control unit may select the corresponding geofence out of a set of different geofences that may be stored in a memory of the second control unit and automatically activate the corresponding geofence. Thus, interaction of an operator may be reduced and safety may be enhanced.

The at least one precondition may comprise an applied parking brake HMI of the second vehicle.

The parking brake HMI is a human machine interface (HMI) to apply or release a parking brake actuator of the vehicle. The parking brake HMI may be designed as a brake lever, for example as disclosed in the International application PCT/IB2022/060583. When the parking brake HMI is applied, for example by pulling up the brake lever, the parking brake actuator is applied and holds the second vehicle at standstill. Thus, an unintentional driving away of the second vehicle before the leader-follower mode has been activated may be prevented. Additionally, the second control unit may be prevented to send a request for activation of the leader-follower mode before a parking brake HMI of the second vehicle is applied.

The second control unit may be configured to enable a request for activation of the leader-follower mode if one, two, three or more of the aforementioned preconditions are fulfilled. Alternatively, the second control unit may be configured to enable a request for activation of the leader-follower mode if all of the aforementioned preconditions are fulfilled.

The second control unit may be configured to detect at least one vehicle configured to operate in a leader mode and to determine of one of the at least one vehicle configured to operate in a leader mode as first vehicle for establishing a communication connection.

The operator may define one or more vehicles of a vehicle fleet to be operable in the leader mode for providing a range of vehicles to be selected as the first vehicle. The vehicles being operable in the leader mode may send a corresponding signal to the second vehicle for indicating readiness to establish a communication connection with the second vehicle. The second control unit may control a screen to display the vehicles being operable in the leader mode to the operator so that the operator may take a decision with which of the vehicles operable in the leader mode the second vehicle shall establish a communication connection. When the communication connection has been established, the first vehicle and the second vehicle may send signals or data to each other for controlling the leader-follower operation.

The second control unit may be configured to send a request for activation of the leader-follower mode to the first vehicle.

The activation of the leader-follower mode may be requested automatically when the first vehicle for establishing the communication connection has been selected or by a separate operator input. Then, the request may be submitted from the second vehicle to the first vehicle. Thus, an unintentional activation of the leader-follower mode may be prevented unless the request has been confirmed.

The first control unit may be configured to receive the request for activation of the leader-follower mode from the second vehicle, to receive a confirmation of the request for activation of the leader-follower mode and to enable the activation of the leader-follower mode when the request for activation of the leader-follower mode has been confirmed.

The request for activation of the leader-follower mode may be confirmed by the operator. The leader-follower mode may be activated automatically in combination with the confirmation of the request for activation of the leader-follower mode or by a separate operator input. Since the request for activation of the leader-follower mode and the confirmation of the request are done on two different vehicles, the first and the second vehicle are involved for activating the leader-follower mode. As consequence, the operator may not activate the leader-follower mode without having an interaction with both vehicles.

The first control unit may be configured to receive the confirmation of the request for activation of the leader-follower mode and to receive a command to activate the leader-follower mode from a first leader-follower mode HMI of the first vehicle.

The first leader-follower mode HMI of the first vehicle may be designed as an button shaped activation device integrated in a brake lever mechanism, for example as disclosed in the International application PCT/IB2022/060583. The operator may use the first leader-follower mode HMI to confirm the request for activation of the leader-follower mode as well as to activate the leader-follower mode. The first leader-follower mode HMI may send a signal to the first control unit when the first leader-follower mode HMI is operated by the operator.

The first control unit may be configured to prevent sending control signals to the second vehicle when the leader-follower mode is inactive.

Thus, the operator may not be able to control the second vehicle remotely from the first vehicle unless the leader-follower mode has been explicitly activated. Additionally, the second control unit of the second vehicle being erroneously activated for executing a leader-follower operation may not receive a corresponding control signal from the first vehicle and initiate an unintentional autonomous operation.

The second control unit may be configured to release a parking brake actuator of the second vehicle when the signal to activate the leader-follower mode has been received.

Since an applied parking brake actuator may be used to prevent an unintentional drive away of the second vehicle before the leader-follower mode has been activated, the parking brake actuator can be released when the leader-follower mode has been activated to enable a drive away of the second vehicle. The parking brake actuator may be designed as a lockable brake actuator also used for service braking as exemplarily disclosed in EP 1 064 182 B1. In case of such a design, the parking brake actuator may be released by unlocking the brake actuator. Instead, other designs of the parking brake actuator are possible.

The second control unit may be configured to override a brake command received from a parking brake HMI of the second vehicle.

Thus, it may not be needed to release the parking brake HMI for releasing the parking brake actuator. Instead, the parking brake HMI may be still applied. But if a failure occurs the signal override of the second control unit will be canceled so that the applied parking brake HMI causes the parking brake actuator to be applied. So, the second vehicle will be automatically braked by the parking brake actuator in case of a failure to prevent any accidents.

The second control unit may be configured to receive a signal to activate the leader-follower mode from the first vehicle and to activate an automated brake control and an automated steering control of the second vehicle when the second control unit has received the signal to activate the leader-follower mode.

Thus, the second vehicle may not be braked or steered by a manual interaction of the operator only but also by a braking signal or a steering signal generated automatically without a manual interaction. So, the second vehicle may be controlled automatically and operated unmanned for following the first vehicle.

Another aspect includes a method for a secure activation of a leader-follower mode comprising the steps of checking if at least one precondition for enabling to request an activation of a leader-follower mode may be fulfilled and enabling to request the activation of the leader-follower mode if the at least one precondition if fulfilled.

The method may be carried out by the control unit. The at least one precondition may prevent that the leader-follower mode will be unintentionally activated, for example, if the second vehicle is not ready to be operated as a follower vehicle. The at least one precondition may ensure that the vicinity of the second vehicle is free of any (living) obstacles. Thus, the risk of accidents or injuries caused by the second vehicle can be reduced. Automated driving of the second vehicle in the follower mode may be prevented if the second control unit of the second vehicle has not received the signal to activate the leader-follower mode and may be enabled after the signal to activate the leader-follower mode has been activated.

The method may disable an activation of the leader-follower mode unless the second control unit has received a confirmation of a request for activation of the leader-follower mode. The method may send a request for activation of the leader-follower mode to be confirmed before activation of the leader-follower mode. The method may ignore any signal to activate the leader-follower mode sent to the second vehicle as long as the method has not received the confirmation of the request for activation of the leader-follower mode. Thus, the leader-follower mode may not be activated unintentionally for the second vehicle.

The at least one precondition may comprise the precondition of an applied parking brake HMI of the second vehicle, the precondition of an established communication connection between the first vehicle and the second vehicle, the precondition of an activated sensor for environmental perception of the second vehicle, the precondition of an activated geofence for the second vehicle, the precondition of an operable automated service brake of the second vehicle and/or the precondition of an operable automated steering of the second vehicle.

As already explained above, the preconditions may ensure that the second vehicle is in an operable status without any defects that may cause an accident or that safety measures are active that may prevent an accident if a failure of the second vehicle occurs. The method may enable a request for activation of the leader-follower mode if one, two, three or more of the aforementioned preconditions are fulfilled. Alternatively, the method may enable a request for activation of the leader-follower mode if all of the aforementioned preconditions are fulfilled.

The method may comprise the steps of requesting the activation of the leader-follower mode and preventing an activation the leader-follower mode unless the request for the activation of the leader-follower mode was confirmed.

The confirmation of the request for the activation of the leader-follower mode may require an interaction of an operator. The operator may be prompted to do a system or a safety check of the first or the second vehicle before a confirmation. Thus, safety may be increased and an unintentional activation of the leader-follower mode may be prevented unless the request has been confirmed.

The method may comprise the steps of enabling a release of a parking brake actuator of the second vehicle when the leader-follower mode has been activated.

The applied parking brake actuator may prevent an unintentional drive away of the second vehicle before the leader-follower mode has been regularly activated. The method may override a brake signal generated by an applied parking brake HMI to release the parking brake actuator. If a failure occurs, the overriding of the brake signal may be cancelled so that the applied parking brake HMI may cause the parking brake actuator to be applied and to decelerate or stop the second vehicle. Thus, the risk of an accident in case of a failure may be reduced.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Several aspects of the invention will now be described, by way of example only, with reference to the accompanying drawings, in which:

FIG. 1 illustrates a vehicle combination comprising a first vehicle and a second vehicle.

FIG. 2 illustrates a block diagram of the first vehicle of the vehicle combination.

FIG. 3 illustrates a block diagram of the second vehicle of the vehicle combination.

FIG. 4 illustrates a simplified view of a control unit.

FIG. 5A illustrates a first part of a flow diagram.

FIG. 5B illustrates a second part of the flow diagram.

### DETAILED DESCRIPTION

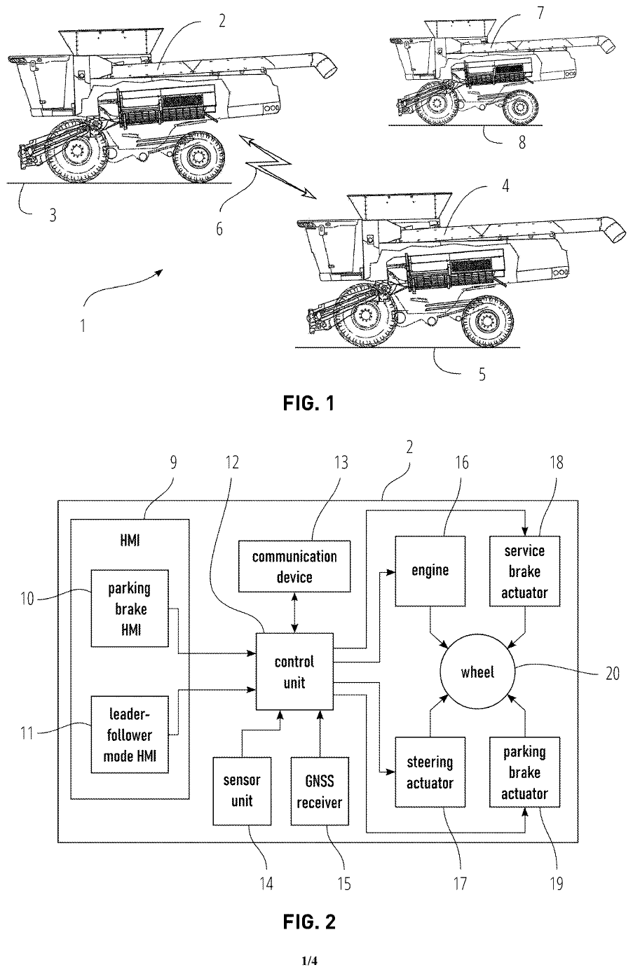

FIG. 1 shows a first vehicle 2, a second vehicle 4 and a third vehicle 7. The three vehicles 2, 4 and 7 are exemplarily illustrated as a harvester without any limitation to such type of vehicle. Instead, the vehicles 2, 4 and 7 could be of any other type such as a tractor pulling an implement, a sprayer, a windrower or any other vehicle. The vehicles 2, 4 and 7 may be located in an agricultural field and positioned each on a separate path or track. For example, the first vehicle 2 may be positioned on a path 3, second vehicle 4 on a path 5 and third vehicle 7 on a path 8. The paths 3 to 8 may be parallel to each other. Alternatively, at least two of the three vehicles 2, 4 and 7 may be positioned behind each other on a single path. At least two of the three vehicles 2, 4 and 7 can be part of a vehicle combination 1. The vehicle combination 1 may be used for a leader-follower operation wherein one of the vehicle is operated in a leader mode and the other vehicles of the vehicle combination 1 are operated in a follower mode following the vehicle operated in leader mode. The three vehicles 2, 4 and 7 provide a connectivity 6 so that all vehicles of a vehicle combination 1 can exchange signals/data between each other.

FIG. 2 shows a block diagram of the first vehicle 2. The first vehicle 2 comprises a first control unit 12 connected with a human machine interface, in the following HMI 9, a communication device 13, a sensor unit 14, a position detector based on a global navigation satellite system (GNSS) in terms of a GNSS receiver 15, an engine 16, a steering actuator 17, a service brake actuator 18, a parking brake actuator 19 and at least one wheel 20. The wheel 20 can be driven by the engine 16 to propel the first vehicle 2. The steering actuator 17 may turn the wheel 20 to change the driving direction of the first vehicle 2. The service brake actuator 18 may apply a brake force to the wheel 20 to decelerate and stop the first vehicle 2. The parking brake actuator 19 may apply a brake force to the wheel 20 to hold the first vehicle 2 at standstill. The service brake actuator 18 and the parking brake actuator 19 may be a combined actuator. The combined actuator may have a latch to block an applied service brake actuator 18. I. e., the parking brake force will be provided by the service brake actuator 18 that is hold by the latch in an applied position. The parking brake force will be canceled when the latch releases the service brake actuator 18 again.

The first control unit 12 may automatically control the engine 16, the steering actuator 17, the service brake actuator 18 and the parking brake actuator 19. Based on position signals received from the GNSS receiver 15, the control unit 12 may automatically navigate the first vehicle 2 from a starting point to a destination point. The sensor unit 14 comprises at least a sensor for environmental perception, as for example a camera, to detect any obstacle in the vicinity of the first vehicle 2. In case of any detected obstacle, the first control unit 12 may automatically apply the service brake actuator 18 to stop the first vehicle 2 before colliding with the obstacle or automatically control the steering actuator 17 to bypass the obstacle.

The communication device 13 of the first control unit 12 is configured to establish a communication connection with another vehicle, as for example the second vehicle 4, for exchanging signals or data between the connected vehicles. The control unit 12 may send commands via the communication device 13 to the connected other vehicle to automatically control leader-follower functionalities, as for example a stop command to brake and halt the second vehicle 4. Thus, the first control unit 12 is configured to be operated in a leader mode as well as in a follower mode.

The HMI 9 comprises a parking brake HMI 10 to manually control the parking brake actuator 19 and a leader-follower mode HMI 11 to manually control leader-follower functionalities. The HMI 9 may comprise additional components such as a steering wheel to manually steer the first vehicle 2 or a brake pedal to apply the service brake actuator 18.

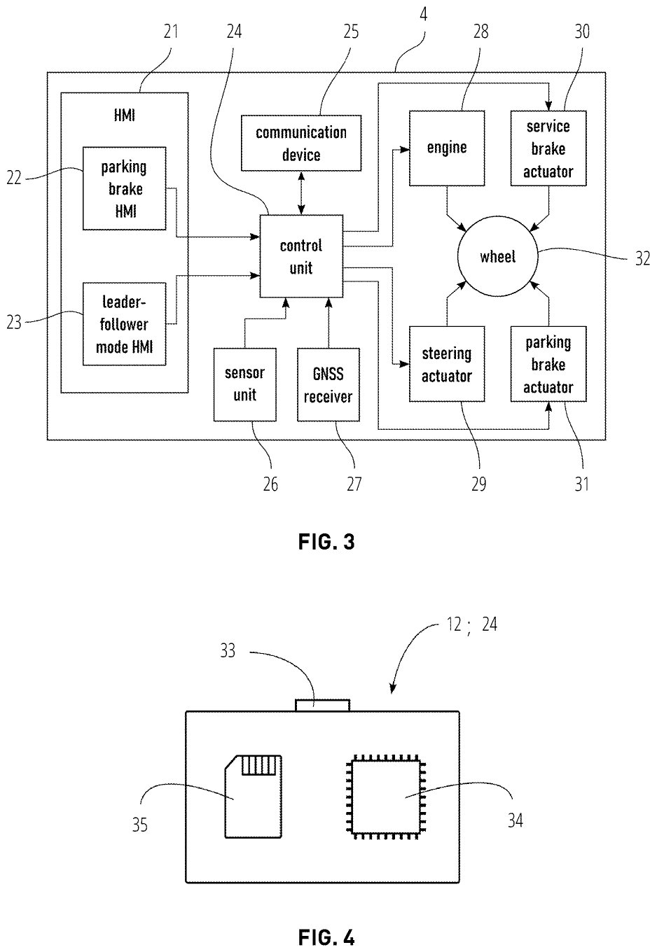

FIG. 3 shows a block diagram of the second vehicle 4. The second vehicle 4 comprises exemplarily the same components as the first vehicle 2: A second control unit 24 connected with a human machine interface, in the following HMI 21, a communication device 25, a sensor unit 26, a position detector based on a global navigation satellite system (GNSS) in terms of a GNSS receiver 27, an engine 28, a steering actuator 29, a service brake actuator 30, a parking brake actuator 31 and at least one wheel 32. The wheel 32 can be driven by the engine 28 to propel the second vehicle 4. The steering actuator 29 may turn the wheel 32 to change the driving direction of the second vehicle 4. The service brake actuator 30 may apply a brake force to the wheel 32 to decelerate and stop the second vehicle 4. The parking brake actuator 31 may apply a brake force to the wheel 32 to hold the second vehicle 4 at standstill. The service brake actuator 30 and the parking brake actuator 31 may be a combined actuator. The combined actuator may have a latch to block an applied service brake actuator 30. I. e., the parking brake force will be provided by the service brake actuator 30 that is hold by the latch in an applied position. The parking brake force will be canceled when the latch releases the service brake actuator 30 again.

The second control unit 24 may automatically control the engine 28, the steering actuator 29, the service brake actuator 30 and the parking brake actuator 31. Based on position signals received from the GNSS receiver 27, the second control unit 24 may automatically navigate the second vehicle 4 from a starting point to a destination point. The sensor unit 26 comprises at least a sensor for environmental perception, as for example a camera, to detect any obstacle in the vicinity of the second vehicle 4. In case of any detected obstacle, the second control unit 24 may automatically apply the service brake actuator 30 to stop the second vehicle 4 before colliding with the obstacle or automatically control the steering actuator 29 to bypass the obstacle.

The communication device 25 of the second control unit 24 is configured to establish a communication connection with another vehicle, as for example the first vehicle 2, for exchanging signals or data between the connected vehicles. The control unit 24 may receive commands via the communication device 25 from the connected other vehicle to automatically control leader-follower functionalities, as for example a stop command to brake and halt the second vehicle 4. Thus, the second control unit 24 is configured to be operated in a leader mode as well as in a follower mode.

The HMI 21 comprises a parking brake HMI 22 to manually control the parking brake actuator 31 and a leader-follower mode HMI 23 to manually control leader-follower functionalities. The HMI 21 may comprise additional components such as a steering wheel to manually steer the second vehicle 4 or a brake pedal to apply the service brake actuator 30.

FIG. 4 shows a schematic illustration of the first and the second control unit 12 and 24. Both control units 12 and 24 comprise an interface 33, a controller 34 and a memory 35. Both control units 12, 24 may receive and send signals or data via the interface 33. The interface 33 may be a wireless interface or a connector. The controller 34 may store the received data or signals in the memory 35. The memory 35 may contain additional data or executable computer program products, for example in terms of a computer-implemented method, that may be retrieved, processed or executed by the controller 34. Data or signals resulting from the processing of data or signals or from the execution of a computer program product may be stored to the memory 35 or sent to the interface 33 by the controller 34.

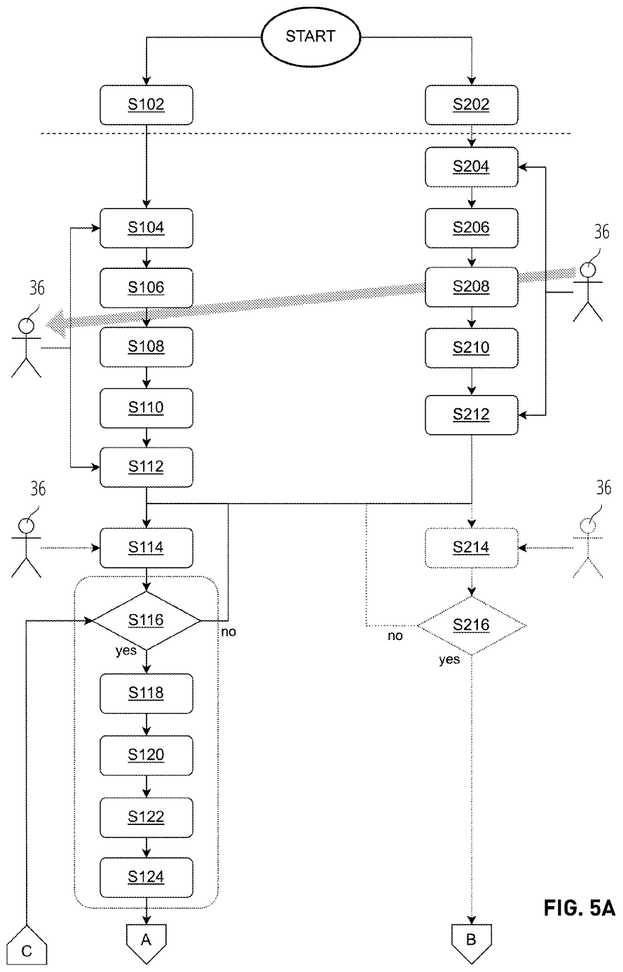

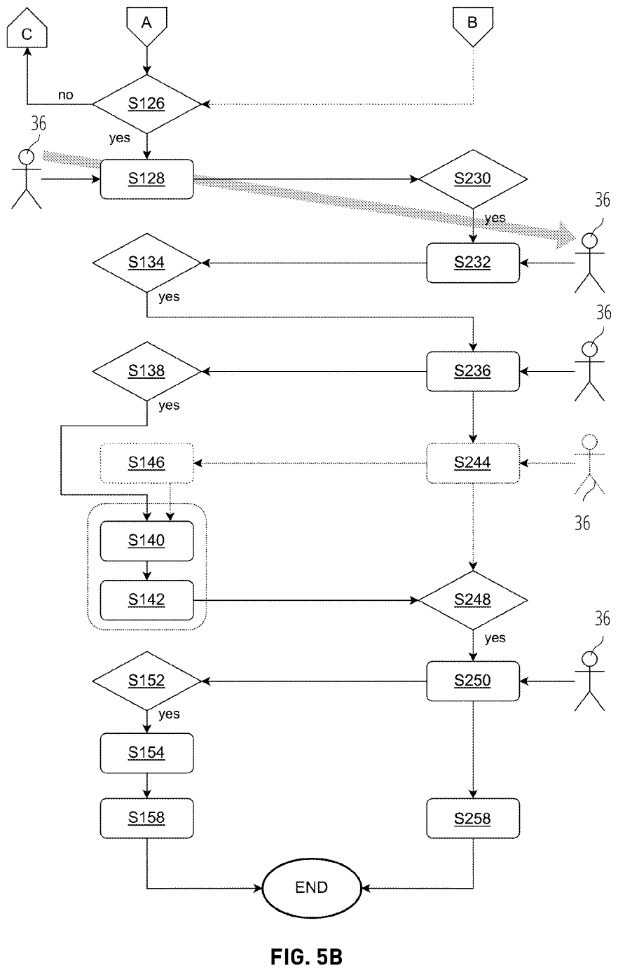

FIG. 5A and FIG. 5B show a flow chart of a method for a secure activation of a leader-follower mode. FIG. 5A shows a first part of the method, FIG. 5B a second part of the method. The method may be at least partly a computer-implemented method stored as a computer program product in the memory 35 of the first and or second control unit 12 or 24. Both control units 12 and 24 are configured to carry out the method at least partly wherein the method may be executed at least partly by the controller 34. The method is described by way of example of several steps without any restriction in respect of that steps. I. e. the number or the order of steps may be adapted, for example single steps may be excluded and/or added and executed earlier or later than described. When started, the method proceeds to step S102 in respect of the second vehicle 4 and to step S202 in respect of the first vehicle 2.

At step S102, the parking brake HMI 22 of the second vehicle 4 is applied to disable the second vehicle 4 from driving away. The applied parking brake HMI 22 triggers the second control unit 24 of the second vehicle 4 to activate the parking brake actuator 31 of the second vehicle 4 to hold the second vehicle 4 at standstill.

At step S202, the parking brake HMI 10 of the first vehicle 2 is applied to disable the first vehicle 2 from driving away. Analogously, the applied parking brake HMI 10 triggers the first control unit 12 of the first vehicle 2 to activate the parking brake actuator 19 of the first vehicle 2 to hold the first vehicle 2 at standstill.

The parking brake HMI 10 of the first vehicle 2 and the parking brake HMI 22 of the second vehicle 4 may be applied by an operator 36 who may have entered the first vehicle 2 now.

The method proceeds to step S204 while the operator 36 starts the engine 16 of the first vehicle 2.

Then, the method proceeds to step S206 and the first control unit 12 activates a manual brake control for controlling the service brake actuator 18 of the first vehicle 2. For example, a brake booster is initialized to support a manual application of the service brake actuator 18 for braking the first vehicle 2.

The method proceeds to step S208 and the first control unit 12 activates a manual steering control for controlling the steering actuator 17 of the first vehicle 2. For example, a servo unit is initialized to support a manual steering activity of the steering actuator 17 for steering the first vehicle 2. Analogously to steps S206 and S208, further components of the first vehicle 2 may be initialized.

The method proceeds to step S210 to set the operation mode of the first vehicle 2. Generally, the operation mode may be set to leader mode or follower mode. For the following description, it is exemplarily assumed that the operator 36 sets the operation mode of the first vehicle 2 to leader mode. The leader mode may be set by controlling the leader-follower mode HMI 11 of the first vehicle 2.

The method proceeds to step S212 and the first control unit 12 activates a connectivity 6. For example, the communication device 13 of the first vehicle 2 is initialized for establishing a communication connection between the first vehicle 2 and another vehicle such as the second vehicle 4 for exchanging signals and/or data. Since the operation mode of the first vehicle 2 is set to leader mode the communication device 13 sends out a corresponding signal to indicate to other vehicles that the first vehicle 2 is ready to establish a communication connection with a follower vehicle.

Now, the operator 36 changes the vehicle and enters the second vehicle 4. The method proceeds to step S104 while the operator 36 starts the engine 28 of the second vehicle 4.

Then, the method proceeds to step S106 and the second control unit 24 activates a manual brake control for controlling the service brake actuator 30 of the second vehicle 4. For example, a brake booster is initialized to support a manual application of the service brake actuator 30 for braking the second vehicle 4.

The method proceeds to step S108 and the second control unit 24 activates a manual steering control for controlling the steering actuator 29 of the second vehicle 4. For example, a servo unit is initialized to support a manual steering activity of the steering actuator 29 for steering the second vehicle 4. Analogously to steps S106 and S108, further components of the second vehicle 4 may be initialized.

The method proceeds to step S210 to set the operation mode of the first vehicle 2. Generally, the operation mode may be set to leader mode or follower mode. For the following description, it is exemplarily assumed that the operator 36 sets the operation mode of the first vehicle 2 to follower mode. The follower mode may be set by controlling the leader-follower mode HMI 23 of the first vehicle 2.

The method proceeds to step S112 and the second control unit 24 activates a connectivity 6. For example, the communication device 25 of the second vehicle 4 is initialized for establishing a communication connection between the second vehicle 4 and another vehicle such as the first vehicle 2 for exchanging signals and/or data. Since the operation mode of the second vehicle 4 is set to follower mode the communication device 25 sends out a corresponding signal to indicate to other vehicles that the second vehicle 4 is ready to establish a communication connection with a leader vehicle.

Before leader-follower mode can be activated, safety should be ensured to reduce the risk of any accidents that may be caused by the vehicle operating in follower mode when driving unmanned. Thus, the method provides several preconditions to activate the leader-follower mode for risk reduction that can be executed by the first or second control unit 12 or 24. The precondition can be
an applied parking brake HMI 22 of the second vehicle 4,
an established communication connection between the first vehicle 2 and the second vehicle 4,
an activated geofence for the second vehicle 4,
an activated sensor for environmental perception of the second vehicle 4,
an operable automated service brake of the second vehicle 4, or
an operable automated steering of the second vehicle 4, or
any combination of at least two of the aforementioned preconditions. Optionally, additional preconditions may be defined.

As mentioned before at step S102, parking brake HMI 22 of the second vehicle 4 has been applied so that one of the preconditions for activating the leader-follower mode is fulfilled already.

The method proceeds to step S114 and second control unit 24 receives via the communication device 25 the signal from the first vehicle 2 indicating to be ready for establishing a communication connection with a follower vehicle. In addition, the communication device 25 of the second vehicle 4 may receive additional signals from other vehicles being set to leader mode. For example, the third vehicle 7 may be set to leader mode and send a corresponding signal to the second vehicle 4. I. e., the second control unit 24 detects at least one vehicle 2, 7 configured to operate in a leader mode.

The second control unit 24 may show all detected vehicles set to leader mode for establishing a communication connection with the second vehicle 4 to the operator 36 on a display of the leader-follower mode HMI 23. Then, the operator 36 can select a vehicle set to leader mode for establishing the communication connection, for example the first vehicle 2 or the third vehicle 7. For the following description, it is exemplarily assumed that the operator 36 selects the first vehicle 2 for establishing a communication connection. So, based on the selection of the operator 36, the second control unit 24 determines the first vehicle 2 for establishing a communication connection. Then, the communication device 13 of the first control unit 12 and the communication device 25 of the second control unit 24 link with each other to establish the communication connection with the first vehicle 2 to be operated in leader mode and the second vehicle 4 to be operated in follower mode. Hence, the first vehicle 2 and the second vehicle 4 have a common connectivity 6 to exchange signals/data between both vehicles for a leader-follower operation.

The method proceeds to step S116 and the second control unit 24 performs a self-check of the communication connection. For example, the second control unit 24 sends a test signal to the first control unit 12 to check whether the communication connection is working properly. If not, the method steps back to step S114 to repeat the step of establishing a communication connection. If the communication connection works the second control unit 24 sends a corresponding confirmation signal to the first control unit 12 and the method proceeds to step S118. Then, a second precondition for activating the leader-follower mode is fulfilled.

Optionally, the operator 36 may select a vehicle set to follower mode for establishing the communication connection. In this case, the method proceeds after step S212 to step S214 and the first control unit 12 receives via the communication device 13 the signal from the second vehicle 4 indicating to be ready for establishing a communication connection with a leader vehicle. In addition, the communication device 13 of the first vehicle 2 may receive additional signals from other vehicles being set to follower mode. For example, the third vehicle 7 may be set to follower mode and send a corresponding signal to the first vehicle 2. The first control unit 12 may show all detected vehicles set to follower mode for establishing a communication connection with the first vehicle 2 to the operator 36 on a display of the leader-follower mode HMI 11. Then, the operator 36 can select a vehicle set to follower mode for establishing the communication connection, for example the second vehicle 4 or the third vehicle 7. For the following description, it is exemplarily assumed that the operator 36 selects the second vehicle 4 for establishing a communication connection. Then, the communication device 13 of the first control unit 12 and the communication device 25 of the second control unit 24 link with each other to establish the communication connection with the first vehicle 2 to be operated in leader mode and the second vehicle 4 to be operated in follower mode. Hence, the first vehicle 2 and the second vehicle 4 have a common connectivity 6 to exchange signals/data between both vehicles for a leader-follower operation.

In addition, method step S214 may optionally be repeated to select the third vehicle 7 as an additional vehicle to be operated in follower mode. In this case, the vehicle combination 1 would comprise the first vehicle 2, the second vehicle 4 and the third vehicle 7 wherein the second and the third vehicle 4 and 7 would both be operated in follower mode to follow the first vehicle 2 operated in leader mode.

After step S214, the method proceeds to step S216 and the first control unit 12 performs a self-check of the communication connection. For example, the first control unit 12 sends a test signal to the second control unit 24 to check whether the communication connection is working properly. If not, the method steps back to step S214 to repeat the step of establishing a communication connection. If the communication connection works the first control unit 12 sends a corresponding confirmation signal to the second control unit 24.

After step S116, the method proceeds to step S118 and the second control unit 24 activates a predefined geofence. The geofence is a virtual fence to enclose an area in which the second vehicle 4 is allowed to operate automatically as for example at least a part of an agricultural field and to exclude areas in which the second vehicle 4 is not allowed to operate automatically as for example public roads. The second control unit 24 determines the position of the second vehicle 4 based on the position signal received from the GNSS receiver 27 and determines whether the second vehicle 4 is located in an area covered by a predefined geofence. If so, the second control unit 24 may select the corresponding geofence out of a set of different predefined geofences that may be stored in the memory 35 of the second control unit 24 and automatically activate the corresponding geofence. Alternatively, the operator 36 may select and activate a geofence for the second vehicle 4. Then, a third precondition for activating the leader-follower mode is fulfilled.

The activation of the geofence for the second vehicle 4 prevents the second vehicle 4 to cross unintentionally the geofence and to drive automatically from an area covered by the geofence in an area excluded by the geofence (crossing the geofence for driving in an area covered by a geofence may be allowed). The second control unit 24 compares the position of the second vehicle 4 with the geofence. When the second vehicle 4 approaches the geofence, the second control unit 24 controls the service brake actuator 30 to automatically stop the second vehicle 4 before crossing the geofence or controls the steering actuator 29 to automatically turn the second vehicle 4 before crossing the geofence. Thus, an unintentional escape of the second vehicle 4 out of the geofence can be prevented.

The method proceeds to step S120 and the second control unit 24 activates a sensor for environmental perception of the second vehicle 4. The sensor for environmental perception is part of the sensor unit 26 of the second vehicle 4 and is configured to detect obstacles in the vicinity of the second vehicle 4. The sensor for environmental perception may be of type of a camera, a lidar, a radar or any other type appropriate for object detection. The obstacles may be living or non-living obstacles as well as moving or static obstacles. The second control unit 24 is receives the information captured by the sensor for environmental perception or the information of an detected obstacle from the sensor unit 26. If an obstacle is detected by the sensor unit 26 or the second control unit 24, the second control unit 24 controls the service brake actuator 30 of the second vehicle 4 to stop the second vehicle 4 before colliding with the obstacle or controls the steering actuator 29 of the second vehicle 4 to bypass the obstacle. Then, a fourth precondition for activating the leader-follower mode is fulfilled.

The method proceeds to step S122 and the second control unit 24 checks the operability of the service brake of the second vehicle 4 for an automated control. The second control unit 24 triggers a test routine to check the functionality of the service brake actuator 30 of the second vehicle 4. For example, the second control unit 24 may check whether a brake force exerted by the service brake actuator 30 corresponds to a force value as commanded by the second control unit 24. If the test routine has been passed a fifth precondition for activating the leader-follower mode is fulfilled. The method proceeds to step S124 and the second control unit 24 checks the operability of the steering of the second vehicle 4 for an automated control. The second control unit 24 triggers a test routine to check the functionality of the steering actuator 29 of the second vehicle 4. For example, the second control unit 24 may check whether a steering angle of the wheel 32 corresponds to a steering value as commanded by the second control unit 24. If the test routine has been passed a sixth precondition for activating the leader-follower mode is fulfilled.

After step S124 or step S216, the method proceeds to step S126 and the second control unit 24 checks whether a sufficient number of the aforementioned preconditions is fulfilled. A sufficient number may be fulfilled if all preconditions are fulfilled. Alternatively, a number smaller than all preconditions may be sufficient. As long as the number of fulfilled preconditions is not sufficient, the method steps back to step S116 to prevent requesting for an activation of the leader-follower mode. Otherwise, if the number of fulfilled preconditions is sufficient, the method enables requesting for an activation of the leader-follower mode and proceeds to step S128.

Then, the operator 36 can operate the leader-follower mode HMI 23 of the second vehicle 4 to request the activation of the leader-follower mode. At step S128, the second control unit 24 receives the request for activation of the leader-follower mode from the leader-follower mode HMI 23. Alternatively, the second control unit 24 requests the activation of the leader-follower mode automatically when a sufficient number of preconditions is fulfilled. Thereupon, the second control unit 24 sends the request for activation of the leader-follower mode to the first vehicle 2.

The method proceeds to step S230 and the first control unit 12 checks whether a request for activation of the leader-follower mode has been received. The first control unit 12 may receive the request for activation of the leader-follower mode from the second vehicle 4. As long as no request for activation of the leader-follower mode has been received by the first control unit 12 the first control unit 12 may prevent to send a confirmation signal to confirm the request for activation of the leader-follower mode. If the request for activation of the leader-follower mode has been received by the first control unit 12 the method proceeds to step S232.

At step S232, the first control unit 12 prompts the operator 36 to confirm the received request for activation of the leader-follower mode. A corresponding prompt may be displayed on a display of the leader-follower mode HMI 11 of the first vehicle 2. The operator 36, who may have entered the first vehicle 2 again, can operate the leader-follower mode HMI 11 of the first vehicle 2 to confirm the request for activation of the leader-follower mode. The first control unit 12 receives the confirmation of the request for activation of the leader-follower mode from the leader-follower mode HMI 11 and sends a confirmation signal to the second vehicle 4.

The method proceeds to step S134 and the second control unit 24 checks whether the request for activation of the leader-follower mode has been confirmed. As long as the request for activation of the leader-follower mode has not been confirmed the method prevents an activation of the leader-follower mode. Otherwise, if the second control unit 24 has received the confirmation signal from the first vehicle 2 the method enables an activation of the leader-follower mode and proceeds to step S236.

The first control unit 12 prevents sending control signals for automatically controlling the second vehicle 4 when the leader-follower mode is inactive. I. e., the operator 36 may control the first vehicle 2 set in leader mode but the second vehicle 4 set in follower mode would not receive any control signals to follow the first vehicle 2. Thus, an unintentional operation of the second vehicle 4 before activation of the leader-follower mode can be prevented.

At step S236, the operator 36 can activate the leader-follower mode by operating the leader-follower mode HMI 11 of the first vehicle 2 after the activation of the leader-follower mode has been enabled by the first control unit 12. The first control unit 12 receives a corresponding signal from the leader-follower mode HMI 11 and activates the leader-follower mode for the first vehicle 2 to be operated in leader mode. Then, the first control unit 12 sends a signal to activate the leader-follower mode to the second vehicle 4.

The method proceeds to step S138 and the second control unit 24 checks whether the signal to activate the leader-follower mode has been received. As long as the signal to activate the leader-follower mode has not been received the method prevents an activation of the leader-follower mode for the second vehicle 4. Otherwise, if the second control unit 24 has received the signal to activate the leader-follower mode from the first vehicle 2, the second control unit 24 activates the leader-follower mode for the second vehicle 4 to be operated in follower mode.

The method proceeds to step S140 and the second control unit 24 activates an automated brake control. Then, the service brake actuator 30 of the second vehicle 4 is operable to be automatically controlled by the second control unit 24 or by a brake command sent from the first control unit 12 to the second vehicle 4 or by a brake command of the operator 36 controlling the second vehicle 4 remotely by the HMI 9 of the first vehicle 2.

The method proceeds to step S142 and the second control unit 24 activates an automated steering control. Then, the steering actuator 29 of the second vehicle 4 is operable to be automatically controlled by the second control unit 24 or by a steering command sent from the first control unit 12 to the second vehicle 4 or by a steering command of the operator 36 controlling the second vehicle 4 remotely by the HMI 9 of the first vehicle 2.

When the automated brake control and the automated steering control has been activated the second control unit 24 sends a signal to the first vehicle 2 to indicate the activated automated brake and steering controls. Thus, automated driving of the second vehicle 4 in the follower mode has been enabled by the second control unit 24.

Optionally, the method may also proceed to step S244 after step S236. At step S244, the operator 36 can define settings for the leader-follower operation in the agricultural field. For example, the operator 36 may define the paths along which the first and the second vehicle 2 and 4 should drive, or define whether the first and the second vehicle 2 and 4 should drive next to each other or behind each other, or define tasks to be performed by the first and the second vehicle 2 and 4 in the agricultural field, or define settings of implements connected with the first and the second vehicle 2 and 4 to be used for the leader-follower operation in the agricultural field. The operator 36 may define additional settings for the leader-follower operation and send the settings to the second vehicle 4.

Then, the method proceeds to the optional step S146 and the second control unit 24 receives the settings for the leader-follower operation sent from the first vehicle 2. As consequence, the second control unit 24 configures the second vehicle 4 according to the received settings for the leader-follower operation. When the configuration has been finished, the method may continue with step S140.

After step S142 or step S244, the method proceeds to step S248. At step 248, the first control unit 12 checks whether the automated brake control and the automated steering control of the second vehicle 4 has been activated. When the first control unit 12 receives the signal from the second vehicle 4 indicating the activated automated brake and steering controls then the vehicle combination 1 is ready for a leader-follower operation.

The method proceeds to step S250 and the first control unit 12 may receive any input of the operator 36 from the HMI 9 of the first vehicle 2 to control the first vehicle 2. When an input of the operator 36 has been received the first control unit 12 may send a signal to the second vehicle 4 for controlling the second vehicle 4 set in follower mode. The method proceeds to step S152 and step S258.

At step S152, the second control unit 24 checks whether a signal to control the second vehicle 4 has been received from the first vehicle 2. If so, the method proceeds to step S154.

At step S154, the second control unit 24 enables a driving away of the second vehicle 4 after the leader-follower mode has been activated. Since the applied parking brake actuator 31 of the second vehicle 4 prevents the second vehicle 4 from driving away, the second control unit 24 releases the parking brake actuator 31 wherein the parking brake HMI 22 of the second vehicle 4 still remains in an applied position. I. e., the second control unit 24 is configured to override or suppress the brake signal received from the parking brake HMI 22 in normal operation to enable automatic driving of the second vehicle 4 to follow the first vehicle 2. For example, the service brake actuator 30 may be unlocked by removing the latch holding the service brake actuator 30 in an applied position to exert a parking brake force. Thus, the second vehicle 4 is enabled to drive and to be braked or stopped by the service brake actuator 30 if a brake actuation is needed. In case of a failure or any other abnormal operation, e. g. an interrupt of the communication connection, the second control unit 24 is not configured to override or suppress the brake signal received from the parking brake HMI 22. Instead, the second control unit 24 executes the brake command demanded by the applied parking brake HMI 22 of the second vehicle 4 to slow down and halt the second vehicle 4 to reduce the risk of any dangerous situation such as a collision.

The method proceeds to step S158 and the second control unit 24 controls the steering actuator 29, the engine 28 and the service brake actuator 30 so that the second vehicle 4 automatically follows the first vehicle 2. The second control unit 24 may process control signals received from the first vehicle 2, signals received from the sensor unit 26 and/or signals received from the GNSS receiver 27 to generate signals for automatically controlling the second vehicle 4 to be operated in follower mode.

At step S258, the first control unit 12 controls the first vehicle 2 according to the signals received from the HMI 9 operated by the operator 36. For example, the operator 36 may release the parking brake HMI 10 to release the parking brake actuator 19 of the first vehicle 2. Then, the operator 36 may control the engine 16, the steering actuator 17 and/or the service brake actuator 18 to operate the first vehicle 2 in the agricultural field. The operator 36 may also control an implement connected with the first vehicle 2. The operator 36 may also activate a guidance system to automatically guide the first vehicle 2 along its path 3.

As can be seen in FIG. 5A and FIG. 5B, the activation of the leader-follower mode for the vehicle combination 1 can be achieved by the operator 36 without changing the vehicles 2 and 4 more than two times. I. e., the operator 36 enters firstly the first vehicle 2, then the second vehicle 4 and lastly the first vehicle 2 again to activate the leader-follower mode. Thus, the FIG. 5A and FIG. 5B discloses next to a method for a secure activation of a leader-follower mode also a method for a very comfortable activation of a leader-follower mode with a very limited number to change the vehicles of the vehicle combination 1.

Finally, the methods end. The method may be restarted again to execute the method another time.

All references cited herein are incorporated herein in their entireties. If there is a conflict between definitions herein and in an incorporated reference, the definition herein shall control.

### LISTING OF DRAWING ELEMENTS

1 vehicle combination
2 first vehicle
3 track
4 second vehicle
5 track
6 connectivity
7 third vehicle
8 track
9 HMI
10 parking brake HMI
11 leader-follower mode HMI
12 control unit
13 communication device
14 sensor unit
15 GNSS receiver
16 engine
17 steering actuator
18 service brake actuator
19 parking brake actuator
20 wheel
21 HMI
22 parking brake HMI
23 leader-follower mode HMI
24 control unit
25 communication device
26 sensor unit
27 GNSS receiver
28 engine
29 steering actuator
30 service brake actuator
31 parking brake actuator
32 wheel
33 interface
34 controller
35 memory
36 operator

What is claimed is:

1. A vehicle combination for a secure activation of a leader-follower mode, comprising:
a first vehicle with
a first control unit configured to operate the first vehicle in a leader mode; and
a second vehicle with
a second control unit configured to
operate the second vehicle in a follower mode;
receive a signal to activate the leader-follower mode; and
enable automated driving of the second vehicle in the follower mode when the signal to activate the leader-follower mode has been received.

2. The vehicle combination of claim 1, wherein the second control unit is configured to disable an activation of the leader-follower mode unless the second control unit has received a confirmation of a request for activation of the leader-follower mode.

3. The vehicle combination of claim 1, wherein the second control unit is configured to enable a request for activation of the leader-follower mode if at least one precondition is fulfilled.

4. The vehicle combination of claim 3, wherein the at least one precondition comprises
the precondition of an established communication connection between the first vehicle and the second vehicle;
the precondition of an activated sensor for environmental perception of the second vehicle;
the precondition of an activated geofence for the second vehicle;
the precondition of an operable automated service brake of the second vehicle; and/or
the precondition of an operable automated steering of the second vehicle.

5. The vehicle combination of claim 4, wherein the second control unit is configured to determine the geofence based on a position signal of the second vehicle.

6. The vehicle combination of claim 3, wherein the at least one precondition comprises an applied parking brake HMI of the second vehicle.

7. The vehicle combination of claim 1, wherein the second control unit is configured to
detect at least one vehicle configured to operate in a leader mode;
determine of one of the at least one vehicle configured to operate in a leader mode as first vehicle.

8. The vehicle combination of claim 1, wherein the second control unit is configured to send a request for activation of the leader-follower mode to the first vehicle.

9. The vehicle combination of claim 6, wherein the first control unit is configured to
receive the request for activation of the leader-follower mode from the second vehicle;
receive a confirmation of the request for activation of the leader-follower mode; and
enable the activation of the leader-follower mode when the request for activation of the leader-follower mode has been confirmed.

10. The vehicle combination of claim 9, wherein the first control unit is configured to receive
the confirmation of the request for activation of the leader-follower mode and
a command to activate the leader-follower mode
from a first leader-follower mode HMI of the first vehicle.

11. The vehicle combination of claim 9, wherein the first control unit is configured to
prevent sending control signals to the second vehicle when the leader-follower mode is inactive.

12. The vehicle combination of claim 1, wherein the second control unit is configured to
release a parking brake actuator of the second vehicle when the signal to activate the leader-follower mode has been received.

13. The vehicle combination of claim 12, wherein the second control unit is configured to
override a brake command received from a parking brake HMI of the second vehicle.

14. The vehicle combination of claim 1, wherein the second control unit is configured to
receive a signal to activate the leader-follower mode from the first vehicle; and
activate an automated brake control and an automated steering control of the second vehicle when the second control unit has received the signal to activate the leader-follower mode.

15. A method for a secure activation of a leader-follower mode, comprising the steps:
Checking if at least one precondition for enabling to request an activation of a leader-follower mode is fulfilled; and
enabling to request the activation of the leader-follower mode if the at least one precondition if fulfilled.

16. The method of claim 15, wherein the at least one precondition comprises
the precondition of an applied parking brake HMI of the second vehicle;
the precondition of an established communication connection between the first vehicle and the second vehicle;
the precondition of an activated sensor for environmental perception of the second vehicle;
the precondition of an activated geofence for the second vehicle;
the precondition of an operable automated service brake of the second vehicle; and/or
the precondition of an operable automated steering of the second vehicle.

17. The method of claim 15, comprising the steps:
Requesting the activation of the leader-follower mode; and
preventing an activation the leader-follower mode unless the request for the activation of the leader-follower mode was confirmed.

18. The method of claim 15, comprising the steps:
enabling a release of a parking brake actuator of the second vehicle when the leader-follower mode has been activated.
